(19) United States
(12) Patent Application Publication
(10) Pub. No.: US 2026/0189103 A1
(43) Pub. Date: Jul. 2, 2026

(54) CLOSED-LOOP APPARATUS FOR ELECTRICAL ENERGY GENERATION

(71) Applicant: Mehmet Kurt, Hungerford, Berkshire (GB)

(72) Inventor: Mehmet Kurt, Hungerford, Berkshire (GB)

(21) Appl. No.: 18/867,890

(22) PCT Filed: May 24, 2023
(86) PCT No.: PCT/GB2023/051361

§ 371 Date: Nov. 21, 2024

(30) Foreign Application Priority Data
May 25, 2022 (GB) 2207702.8

(51) Int. Cl. H02K 7/18

(52) U.S. Cl. CPC H02K 7/1823; H02K 7/1815

(57) ABSTRACT

The invention is focused on energy generation by circulating the compressed air in a closed loop system. This method of electricity generation has one of its many advantages is sustainability. It generates sustainable energy from the compressed air flow by circulating the air source within the closed-loop design. The closed loop design will draw attention to the transportation sector, which is now transitioning from fossil fuels to electric vehicles to reduce carbon emissions. This invention reuses the same air by circulating through the closed loop design and making it a zero-carbon emission system. The closed loop system can be scaled up or scaled down depending on the output current required. This system can be mounted in any transport vehicle that can use the stored current from the system's battery and will be recharged by the system itself. The system is fully programmed in way that Battery Management System (BMS) can communicate between each other to start the system automatically and generate electricity to recharge the battery anytime during the vehicle is moving or stationary. This system has serval versions, which are selected based on the required size and output power.

This invention is focused on energy generation by circulating the compressed air in a closed loop system. This method of electricity generation has one of its many advantages is sustainability. It generates sustainable energy from the compressed air flow by circulating the air source within the closed loop design. This closed loop design will draw attention to the transportation sector, which is now transitioning from fossil fuels to electric vehicles to reduce carbon emissions. This invention reuses the same air by circulating through the closed loop design and making it a zero-carbon emission system.

The closed loop system can be scaled up or scaled down depending on the output current required. This system can be mounted in any transport vehicle that can use the stored current from the system's battery and will be recharged by the system itself. The system is fully programmed in way that Battery Management System (BMS) can communicate between each other to start the system automatically and generate electricity to recharge the battery anytime during the vehicle is moving or stationary. This system has several versions, which are selected based on the required size and output power.

### SUMMARY

The aim of this system is to generate electricity from the compressed air. The compressed air is transferred into the turbine which has single and multiple alternator(s) mounted to the propeller blade shaft. The compressed air feeding the turbine creates momentum or thrust on propeller blade which rotates the rotor(s) of the alternator(s) mounted to the shaft. By using this method, energy can be generated based on given flowrate. Compressed air from the turbine exhaust is collected through the loop and back into the piston which transfers compressed air to the turbine(s). The piston moves forward and backward with the support of electrically powered actuators to compress the air and force it towards the turbine(s). The system can run efficiently on its integrated high power accumulator unit which is recharged when the system is operating, and the accumulator unit have the capacity supply to the external source(s). This sustainable method of electric production generates high current by utilizing low energy, in other words the system will fast recharge the battery unit than total consumption time from the battery by the system and external source(s). This makes closed loop system a unique method in power generating invention.

The project currently focuses in developing closed loop system for cars, bus as a primary target The timeline and priority will decrease, extend, or change according to the project outcome and current market requirements.

### FIELD OF THE INVENTION

The system is designed in such a way, and like that of the human vascular system. It consists of a specially designed piston which functions as a heart of the system (heart pumps blood through blood vessels), it circulates air through the closed loop pipeline (arteries and veins of blood vessels). In between the closed loop the turbine(s) is/are connected (blood vessel connected to body parts). The piston transfers the compressed air into the turbine(s) through the loop (arteries) and collects the utilised air after the turbine back into the piston (veins) and recirculated the same air through the closed loop system for every cycle without any leakage.

The main purpose of the project is to use closed circuit “loop” line(s) with high pressure compressed air (all fluids such as various gases, Co2, Argon, Nitrogen, etc.) and thus to produce electricity with the help of the alternator(s) included within the turbine(s) and working continuously 24/7 as a stand-alone system.

Systems or apparatus of the present disclosure is suitable for application in any system consuming electricity, but more particularly applications including automotive vehicles, commercial vehicles (such as busses), vehicles commonly used for public transport.

The present disclosure relates to the use of compressed fluid, such as atmospheric air or various gases (CO2, Argon, Nitrogen etc.), in the generation of electrical energy. More particularly, the present disclosure relates to a system or apparatus, in which the compressed fluid is circulated through a turbine to generate electrical energy with high efficiency.

### BACKGROUND

With rising costs of fuel and increasing social pressure to move away from fossil fuels and towards a greater dependence on renewable sources of energy, there is a desire to develop ever more efficient engines or renewable energy alternatives.

When it comes to addressing these above-mentioned problems in the development of automotive vehicles there are several problems with existing solutions. Existing reciprocating engines used in hydrocarbon-fuel-powered automotive vehicles suffer from low efficiency and are therefore costly in fuel and are often dependent on fossil fuels entirely. Equally, lithium-ion-battery-powered vehicles and hydrogen-fuel-cell-powered vehicles have a low fuel density and therefore need to carry around more fuel for a given range which reduces energy efficiency in transporting the extra weight. Further, lithium-ion batteries suffer from a long refuel/recharge time.

A problem associated with known renewable sources of electricity generation is the mismatch between the rate of generation and the rate of demand. Solar energy, for example, can only be produced during the day and peaks in the middle of the day whilst peak demand on the UK national grid is usually in the evening. Therefore, there exists a need for storage of electrical energy produced from solar, wind and other renewable sources that cannot be easily tempered with fluctuating demand.

The reasons written above are; necessitated the rapid development of the invention.

### Details of the System

A problem associated with comparable systems which exhaust compressed fluid after circulating it through a turbine may be that the momentum of the exhausted fluid is lost and not utilised in the generation of electrical energy.

If it is necessary to give details; The rotating propeller absorbs the air hitting the propeller. The system has been designed in such a way that the air can easily return again and helps the cycle to be infinity. Loop is one of the most important items of this system. It ensures the complete fulfilment of the cycle for the correct operation of the system. The loop forms the vessels of the aforementioned heart system. Air is the blood that feeds the heart through this vein. In other words, heart system and loop to ensure the integrity of the project: In order to sustain infinity and high-pressure energy. 100 units of electricity are used under normal conditions, and the same high pressure is made with an electricity produced by a 5 unit system thanks to this triple system.

According to a first aspect there is provided an apparatus for generating electrical energy comprising fluid circulating apparatus, suitable for circulating pressurised fluid. The apparatus comprises a first closed-loop pipeline and a second closed-loop pipeline, wherein the first closed-loop pipeline and the second closed-loop pipeline are coupled to a common fluid propulsion means. The fluid propulsion means comprises a first fluid intake and a first fluid output, and a second fluid intake and a second fluid output. The first closed-loop pipeline is coupled to the first fluid output and the first fluid intake of the fluid propulsion means and comprises at least one turbine comprising a turbine fluid intake and a turbine fluid output. The turbine fluid output is connected to the first fluid intake of the fluid propulsion means by the first closed-loop pipeline. The first fluid output of the fluid propulsion means is connected to the turbine fluid intake by the first closed-loop pipeline. The apparatus further comprises at least one alternator coupled to the at least one turbine such that rotation of the at least one turbine provides rotation to the alternator which in turn generates electrical energy. Generated electrical energy is transferred to the battery through the leads from the stator(s) of the alternator(s) which is mounted to the turbine.

The turbine has a special design inlet and outlet which focus and create high thrust on the propeller on the inlet side and acts as an expander on the outlet side. This design drastically reduces the pressure an allows the propeller blade turn smoothly without any back pressure opposing force. This method of compression of air at the inlet and expansion of air at the outlet makes the turbine design more efficient to generate more electricity with less energy spent. The outlet of the turbine is connected to the piston inlet through the pipes which carries the air from the turbine back into the piston and used the same air for the second cycle of the piston.

In addition, the specially designed geometry of the turbine enables the structure to be scaled. In this way, the system can be easily increased or reduced to different dimensions while maintaining the same design parameters and components,

The system comprises a pressure tank configured to provide an initial fluid flow as a kick-start to overcome a start-up inertia of the turbine(s) and maintaining an energy efficiency of the fluid propulsion means by eliminating inrush currents. In some examples the system further comprises a reserve tank for supplying reserve fluid to the fluid circulating apparatus, wherein the reserve tank has a higher pressure than the fluid circulating apparatus.

After certain cycles, the impure air is replaced with fresh air from the reserve tank. The air is released to atmosphere from the loop and replaced synchronously with the air from the reserve tank feed into the system equal to the air exhausted. When the gas bottle loses its pressure, a compressor is connected to refill the gas bottle.

The at least one alternator may be wirelessly coupled to the turbine, for example, the at least one turbine may comprise an axial flux generator base unit electromagnetically coupled with a receiving unit of an alternator to transfer energy into the receiving unit.

The first closed-loop pipeline comprises a plurality of turbines. The fluid propulsion means, and the plurality of turbines may be arranged in line with the closed-loop pipeline. The plurality of turbines comprises at least three turbines and the at least one alternator coupled (either mechanically or wirelessly). In another aspect there is provided an apparatus for generating electrical energy comprising: fluid circulating apparatus, suitable for circulating pressurised fluid, comprising a closed-loop pipeline arranged to connect the components of the fluid circulating apparatus in series or parallel.

The other version of turbine(s) wirelessly coupled to a respective alternator. Each of the turbine(s) comprise an axial flux generator base unit coupled with a receiving unit of a respective alternator to transfer energy into the receiving unit. The axial flux generator base unit include a turbine blade containing built-in multiple permanent magnets that produce a magnetic flux, which passes through a receiver coil comprising windings in the receiving unit. The receiver coil is disposed in a separate housing, and it is electrically connected with a suitable Battery Management System. The permanent magnets of the turbine blade, and/or a flux shunt, is moved in the base unit to produce the varying magnetic flux that is coupled to the receiver coil. As a result of the varying magnetic field experienced by the receiver coil, an electric current is induced in the receiver coil, which is conditioned (e.g., rectified, filtered, and regulated) by a conditioning circuit.

The turbine blades therefore be specially adapted to include a special design turbine blade which rotates either the magnets and/or winding(s) in the turbine. Each of the first, second and third turbines may comprise electromagnetic bearings for superior life span and low friction.

The at least one turbine(s) comprises two identical alternators. This feature can use both alternative current (AC) and direct current (DC) generation depending on the end application.

Piston comprises a cooling means, for cooling the pressurised fluid, comprising a cooling intake and a cooling output, wherein the cooling output is connected to the fluid intake of the fluid propulsion means by at least one of the first and the second closed-loop pipeline. The cooling means comprise any of a fluid discharge valve, a cooling system, a surface cooler which is automated by the PLC to start when the feedback from the sensor initiated. The cooling systems covers mainly the heating areas due to continuous cycle.

The system lubrication method is automated through the PLC logic sequence similar to the cooling method. Input signal is received from the moisture control sensor which is mounted inline to the closed loop system. The oil moisture level in the fluid is set to maintain at a required value and lubricating oil is sprayed into the circulating loop with the precision volume spray nozzle. This keeps the fluid circulating the loop from dryness and protects the moving components from wear and tear and reduce maintenance cost.

The closed-loop pipeline may be enclosed with a third security pipeline. The apparatus for generating electrical energy may, optionally, further comprise at least one security component. The at least one security component may comprise any of: a motorised pressure relief valve and/or a mechanical pressure relief valve.

The apparatus for generating electrical energy further comprise an automation system. The automation system comprises of control valves, check valves, RPM sensors, temperature sensors, pressure sensors, flow sensors, fluid moisture level indicator, condensed water level indicator, control means and/or means for logging measurements.

The monitoring system receives data from input units connected to the automation system and displays generated voltage, current, and frequency from the alternator(s) as well as Battery Management System (BMS) life cycle statistics. Charge level indication, battery run duration, and time until fully charged are BMS monitoring display characteristics. The system is set up to run a range of operation programmes or scenarios without the need for human intervention.

The reserve tank may have a higher pressure than the fluid circulating apparatus and the pressure tank, the reserve tank and the fluid circulating apparatus may all be connected to one another. The apparatus for generating electrical energy may further comprise one, two or three additional pressurised tanks and the tanks may be connected to one another and to the fluid circulating apparatus such that they maintain a continuous flow through the tanks and the fluid circulating apparatus.

The components of the piston comprise a fluid propulsion means comprising a fluid intake and a fluid output, wherein the fluid propulsion means comprises an electronically actuated cylinder pump system comprising two pairs of counter-reciprocating pistons mounted in respective cylinders, with each pair of pistons arranged to be driven by a common actuator, and at least on turbine comprising a turbine intake and a turbine output. The turbine output is connected to the fluid intake by the closed-loop pipeline. The fluid output of the fluid propulsion means is connected to the turbine intake by the closed loop pipeline.

The apparatus further comprise a reserve tank arranged to supply reserve fluid to the piston, a pressure tank for providing an initial fluid flow as a kick-start to overcome a start-up inertia of the at least one turbine, the pressure tank comprising a compressor to maintain a predetermined pressure in the pressure tank, and at least one alternator coupled to the at least one turbine such that rotation of the turbine provides rotation to the alternator which in turn generates electrical energy.

The kickstart sequence components such as manifold, open close valve is also connected to a different sequence which is automated by the feedback from pressure sensors connected within the closed loop pipeline. This PLC automated sequence works as an air replacement method in the loop. Releasing the used contaminated air from the loop by operating the open close valve on the exhaust loop in the branch(s) of pipeline and synchronously opening the inlet loop in the branch(s) for a calculated time limit. This releases the used air and replaces pure air from the reserve tank to maintain the system with less contamination.

The fluid propulsion means may comprise two actuators, each actuator configured to drive a corresponding pair of pistons.

The first actuator is configured to move a first pair of pistons in a first direction while the second actuator is configured to simultaneously move the second pair of pistons in an opposite second direction. Each actuator is mounted between its corresponding pair of pistons.

### BRIEF DESCRIPTION OF THE DRAWINGS

Embodiments of the disclosure will now be described, by way of example only, and with reference to the drawings in which:

FIG. 1 schematically illustrates a plan view of an example apparatus of the present disclosure.

FIG. 2 schematically illustrate a plan view of another example apparatus of the present disclosure,

FIG. 3 schematically illustrates a enlarge view of turbine A mounted on piston of an example turbine and turbine housing of the present disclosure.

FIG. 4 schematically illustrates a enlarge view of turbine B mounted on piston of an example turbine and turbine housing of the present disclosure.

FIG. 5 illustrates a perspective view of an example piston of the present disclosure.

FIG. 6 illustrates a perspective view of an example turbine A housing of the present disclosure.

FIG. 7 schematically illustrates a front cross-section of an example turbine A and turbine A housing of the present disclosure.

FIGS. 8X and 8Y schematically illustrate cross-sections depicting first and second positions, respectively, of an example turbine A of the present disclosure.

FIG. 9 schematically illustrates a side cross-section of an example turbine A and turbine A housing of the present disclosure.

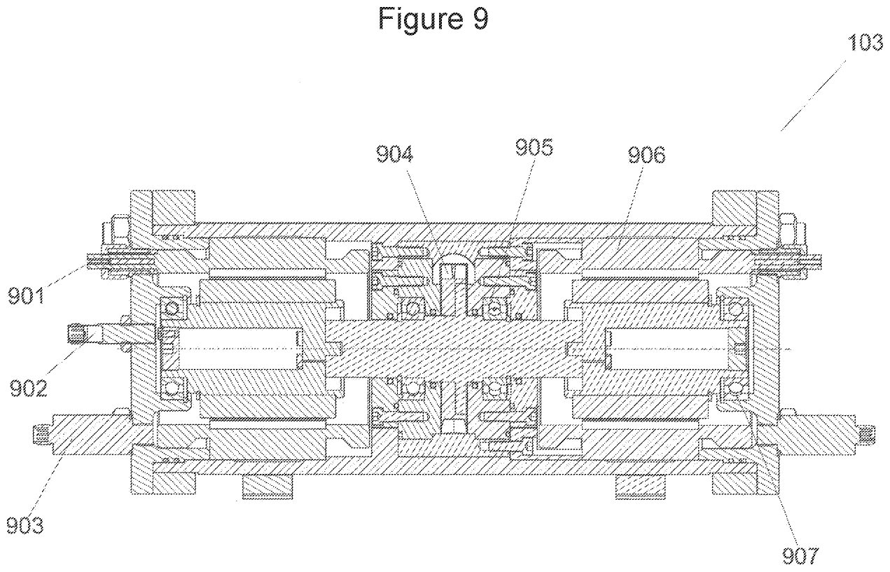

FIG. 10 schematically illustrates a front cross-section of an example turbine B and turbine B housing of the present disclosure.

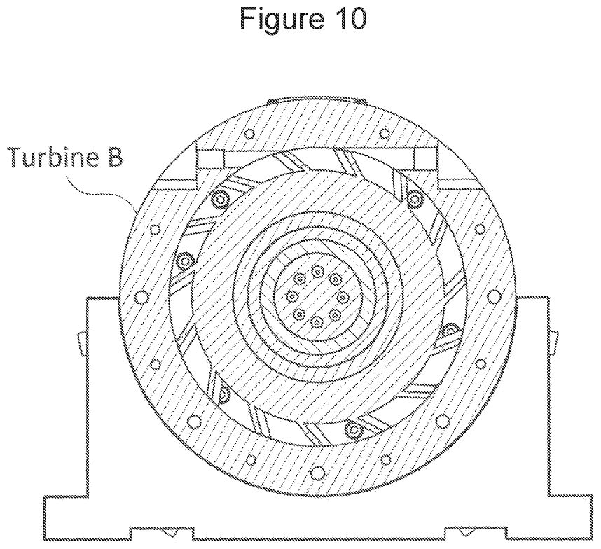

FIG. 11 schematically illustrates a front cross-section of turbine B mounted on piston of an example turbine B and turbine B housing of the present disclosure.

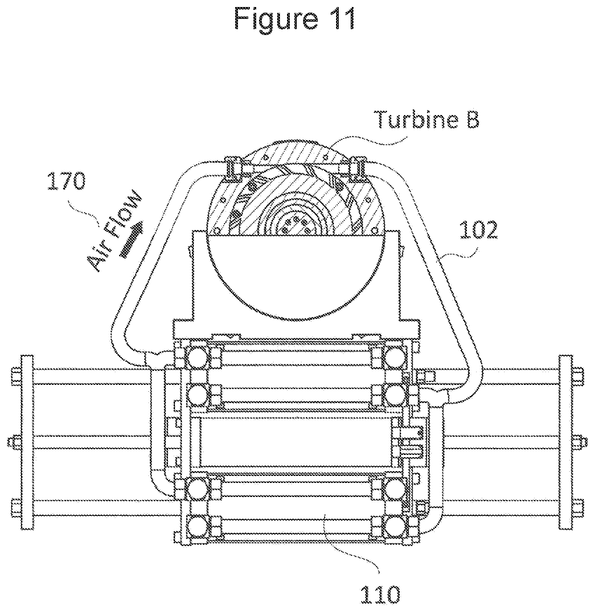

FIG. 12 schematically illustrates a enlarge view of multiple turbine B mounted on piston of an example of the present disclosure.

FIG. 13 schematically illustrates an example electrical interface for generating electrical energy from the example apparatus.

FIG. 14 schematically illustrates another example electrical interface for generating electrical energy from the example apparatus.

### DETAILED DESCRIPTION

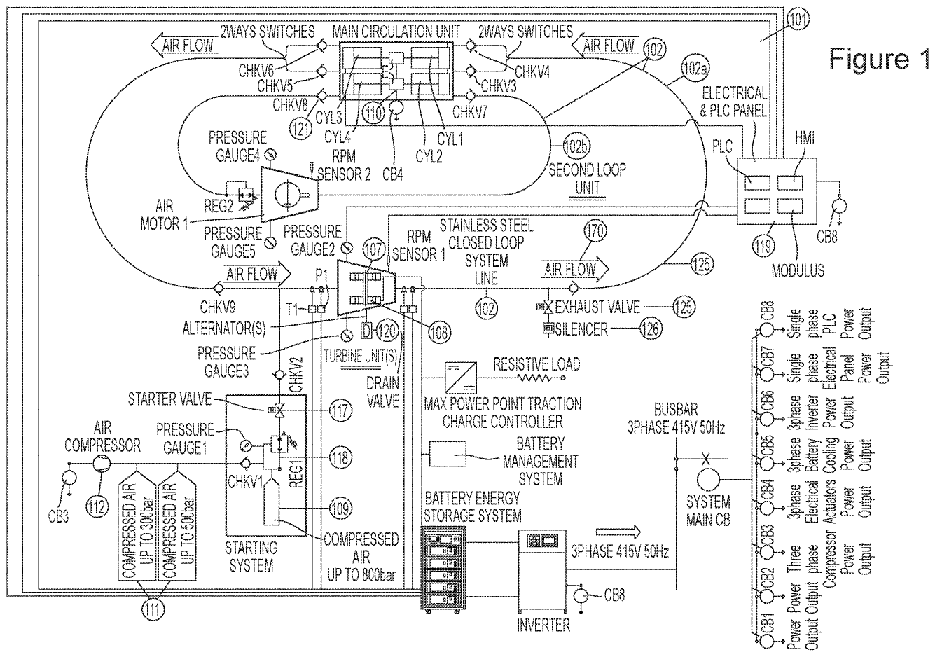

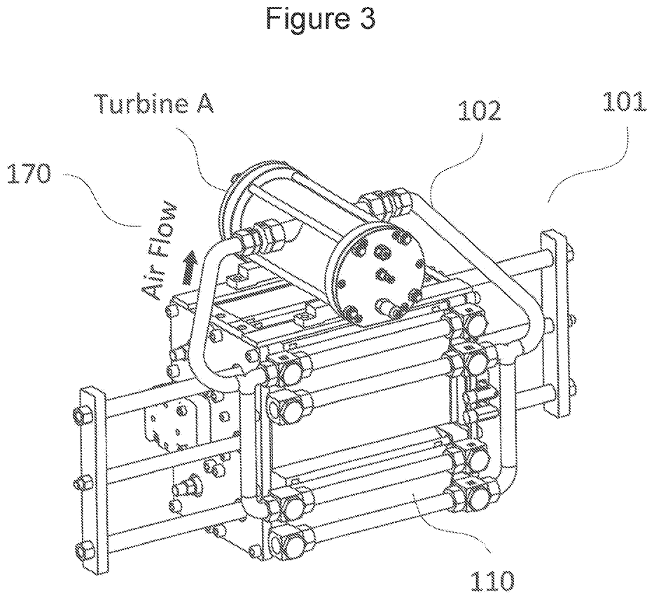

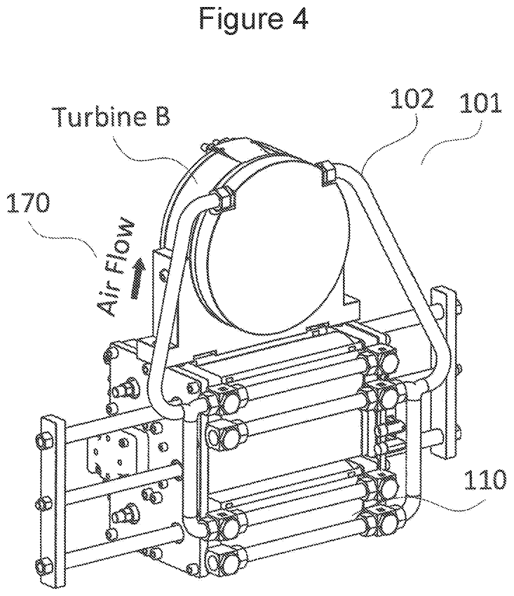

FIGS. 1, 3 and 4 show a first example of a closed loop system 101 which is suitable for circulating pressurised fluid and generating electrical energy. The fluid circulating apparatus comprises a closed-loop pipeline 102 which connects the other components of the piston in series such that the fluid can flow 170 to, from and through each of the components.

The further components of the closed loop system comprise a piston 110, a first turbine 103, a second turbine 104, a third turbine 105 and a cooling, all arranged in series and looping back round to the piston 110 and all connected in order by the closed-loop pipeline 102.

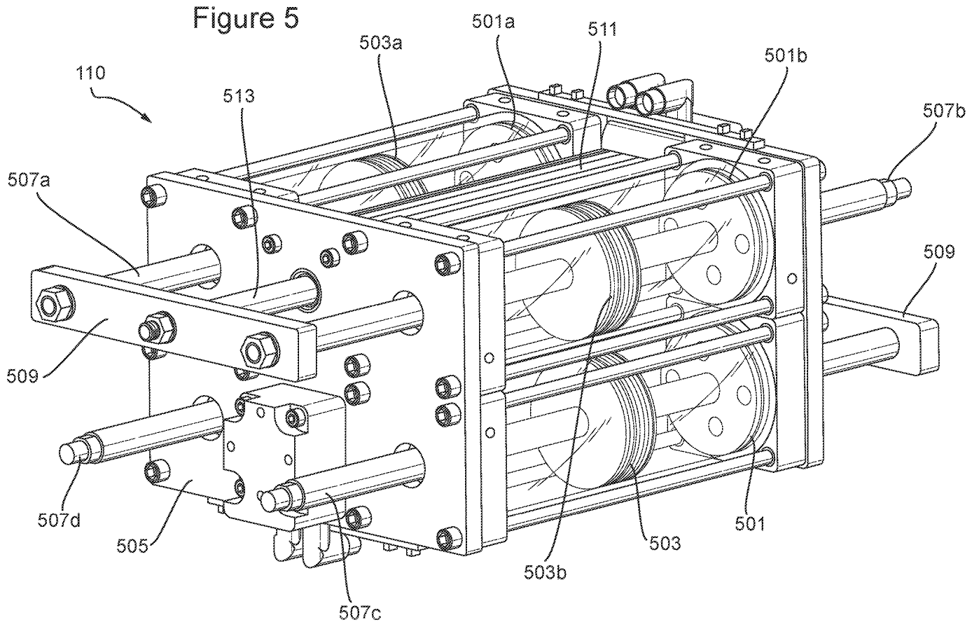

The piston 110 may be an electrically actuated cylinder pump system and/or a screw style air-accelerator. The electrically actuated cylinder pump system may comprise a plurality of counter-actuating or counter-reciprocating cylinder pumps. For example, the electrically actuated cylinder pump may comprise four cylinders each comprising a respective piston, as described below with reference to FIG. 5. The cylinders may be arranged in a symmetrical arrangement, such that the cylinder pump system may have at least one or two lines of symmetry. The pistons of each cylinder may be arranged to operate in a counter-reciprocating motion. Advantageously this may balance out the motion of the pistons to prevent and reduce movement, vibration, and noise from the cylinder pump system.

If the apparatus described above were an open system, air is supplied to the turbines 103, 104, 105 and the energy of the air will be exhausted to atmosphere on exit and therefore lost. To eliminate and improve on this, the invention ensures the air will instead be circulating within one or more closed loop system(s) and therefore retaining the compressed air as it is recirculated by a specially designed piston 110 which, as noted above, an electrically actuated cylinder pump system and/or a screw style air-accelerator. The closed loop system(s) is/are designed in such a way that with fitted check-valves, the compressed air can only ever flow in one direction.

Air enters the initial turbine via a specially designed starter manifold, by means of a loop pipe and continue to expand through the additional turbines if fitted. Final exhaust air from turbine(s) will then pass around the closed loop connection pipe to a fluid propulsion means 110, which is a hybrid arrangement of electrically operated high pressure pneumatic cylinders. On the opposite side of the fluid propulsion means 110, an outlet is provided which connects to the turbine inlet as previously mentioned. Thus, a closed loop for circulating air flow is created. The closed loop is inherently a closed circuit, and its main task is to maintain system air circulation without exhausting directly to the atmosphere and it is intended that any excess pressure in the loop line 102 will be transferred to a reserve tank 109 or pressure tank 111 by an additional control valve system. If necessary, the loop line(s) will either be cooled or heated, and its pressure maintained within set limits by way of pressure relief valves. The loop line(s) manufactured from stainless steel hydraulic grade pipe and as such well within the working pressure range.

In the proposed system, the compressed air flow is unidirectional in the closed-loop pipeline 102. As the energy demand from external loading necessitates alter, the supervisory system will either speed up or slow down the piston 110 to supply the correct amount of compressed air flow through the turbines 103, 104, 105 within the system. The compressed air feed to the turbine 103, 104, 105 shall thus be maintained at sufficiently high levels without deficit.

As noted above, the fluid circulating apparatus include several security components and/or components of a system for providing automation. These include a valved pipeline release 125 which include a nozzle with a silencer 126 for discharging fluid in the event, for example, that operation pressure limits are exceeded. Such a valved pipeline release 125 located immediately after the turbine(s) on the closed-loop pipeline 102.

Further security components include a closed-loop pipeline check valve 121 for preventing back flow of the circulating fluid. Such a closed-loop pipeline check valve 121 located in between the piston 110 and turbine(s) on the closed-loop pipeline 102. The closed loop system 101 includes a mechanical pressure relief valve 125 to discharge fluid in case the operation pressure limited are exceeded.

Fluid circulates around the closed loop system 101 by a piston 110 and propels the turbine(s) by passage of the through them. The turbine(s) is/are airtight (for example when the circulating fluid is air) and comprise airtight bearings and/or electromagnetic bearings. The turbine(s) and the piston 110 connected in line with the closed-loop pipeline 102.

Each of the turbine(s) include a single/pair of alternator(s), mechanically connected to the respective turbine(s) such that rotation of the turbine(s) provides rotation to the alternator(s) which in turn generates electrical energy. The turbine(s) is/are rotated by the circulation of fluid through them. The single/pair of alternator(s) may be identical to one another and may be connected to the same shaft.

The closed loop system for generating electrical energy 101 further comprises a reserve tank 109 mounted to a specially designed manifold 118 which has multiple in/out ports arranged to supply reserve fluid to the fluid circulating apparatus and connected to the closed-loop pipeline 102 by a reserve tank/loop pipeline valved connection 118 and a second reserve tank/loop pipeline valved connection. The first reserve tank/loop pipeline valved connection 118 also comprises a reserve tank/loop pipeline starter valve 117 which only permits the flow of fluid from the reserve tank 106 to the close-loop pipeline 102.

The reserve tank 109 have a higher pressure than the closed-loop pipeline 102 and the first reserve tank/loop pipeline valved connection 118 is provided to supply reserve fluid from the reserve tank 109 to the closed-loop pipeline 102.

The apparatus for generating electrical energy 101 further comprises a reserve tank 109 for providing an initial fluid flow to overcome a start-up inertia of the turbines 103, 104, 105 and for maintaining an energy efficiency of the fluid propulsion means and/or inline compressor by eliminating inrush currents. The starter valve 117 is automated by PLC 119 to provide fluid into the turbine(s) as a kick start function and balance the pressure inside the loop 102 when the pressure drops. The pressure tank 111 comprises a compressor 112 to maintain a predetermined pressure in the pressure tank 111.

In addition to the cooling device, there may also be provided a surface cooler located on the surface of the closed-loop pipeline 102. The surface cooler located on the section of closed-loop pipeline 102 between the cooling device and the fluid propulsion means.

The fluid may also be cooled by being discharged from the apparatus 101 by opening the valved pipeline release 125 and top up equal volume of fluid released from the reserve tank 109 by opening the starter valve 117. The condensation (moisture) will build up/form in the system and will be extracted through suitable drain valve(s) 120 for every 2% of total moisture collected in the loop pipeline which is automated by the PLC to keep valve(s) open for few seconds. In embodiments in which the fluid is air (or other gas) any condensation in the closed-loop pipe 102 line may also be discharged with, for example, an air water separator filter pneumatic regulator.

The apparatus for generating electrical energy 101 further comprise an automation system. Such a system comprises of control valves, check valves, RPM sensors, temperature sensors, pressure sensors, flow sensors, control means and/or means for logging measurements. The monitoring system receives data from feedback units connected to the automation system to display generated voltage, current, frequency from the alternator(s) and battery life cycle parameters from the Battery Management System (BMS). BMS parameters are charge level indicator, run time of battery, time left for fully charged. The system is configured to carry out a variety of operation programmes or scenarios automatically with minimal human intervention.

During operation, loop pipeline valved connection and the valved pipeline release 125 may be opened and the pressurised fluid from the reserve tank 109 generates high fluid speed through the turbines 103, 104, 105. Once the turbines 103, 104, 105 reaches a predetermine speed, the fluid propulsion means (or compressor) 110 is started and the loop pipeline valved connection and the valved pipeline release 125 are closed. An aim of supplying pressurised air from the reserve tank 109 to the fluid propulsion means 110 to maintain an energy efficiency when compare working with 1 standard atmosphere (atm).

If the reserve tank 109 pressure is below a predetermined value, the reserve tank valved connection 118 can be opened to increase the pressure in the reserve tank 109. If the pressure in the closed-loop pipeline 102 rises above a predetermined valve, the mechanical pressure relief valve opens for safety and security purposes. If the pressure in the closed-loop pipeline 102 falls below a predetermined value, the pressure tank/loop pipeline valved connection 118 opened and may be closed if the pressure in the closed-loop pipeline 102 rises above a predetermined value. The fluid propulsion means 110 may be supplied with additional fluid from the reserve tank 109 via the reserve tank/loop pipeline valved connection 118.

In relation to exemplary pressures of the first embodiment, the preferable pressure for the pressure tank 111 up to 300 bar. A preferable pressure for the reserve tank 109 more than 100 bar and a preferable pressure for the close-loop pipeline less than 100 bar.

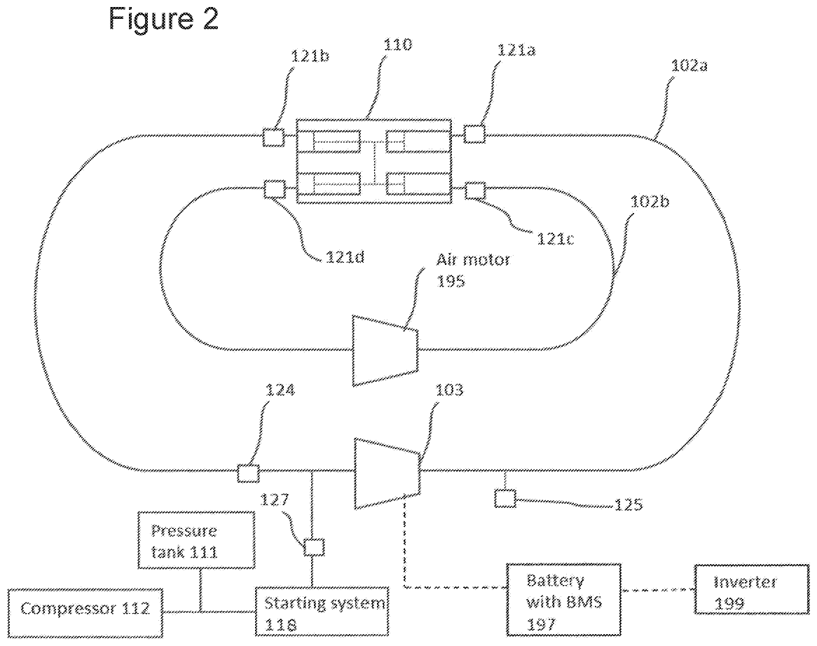

Referring now to FIG. 2, FIG. 2 shows another example of an apparatus 101 for generating electrical energy comprising a fluid circulating apparatus which is suitable for circulating pressurised fluid. The fluid circulating apparatus comprises a first closed-loop pipeline 102a which connects the other components of the fluid circulating apparatus in series such that the fluid can flow to, from and through a turbine(s) 103 coupled to an alternator. The fluid circulating apparatus also comprises a second closed-loop pipeline 102b for circulating fluid though a pneumatic motor 195 such as an air motor. Both the first close-loop pipeline 102a and the second closed-loop pipeline 102b are connected in parallel to the fluid propulsion means 110 which in this example is an electrically actuated cylinder pump system. Both the first closed-loop pipeline 102a and the second closed-loop pipeline 102b is manufactured from stainless steel hydraulic grade piping in special closed loop designs and configuration suitable for supplying compressed air to turbine(s) 103 and/or a pneumatic motor 195 and the fluid propulsion means 110. A smart, fully automated compressor system 112 is coupled to the first closed-loop pipeline 102a via at least one pressure tank 111 and a starting system 190 to maintain the loop pressure at a predefined value. An example of a suitable fluid propulsion means is shown in FIG. 5 and is described in more detail below.

The starting system 109 has a small volume high-pressure cylinder with a specially designed high-pressure manifold and provide replenishing pneumatic pressure for the first closed-loop pipeline 102a and/or the second closed-loop pipeline 102b.

As noted above, the first closed-loop pipeline 102a comprises one or more turbine unit(s) 103 that may comprise single or double inlets depending on the torque requirement, and if there are a plurality of turbines 103 these are sequentially connected in-line (i.e., in series) with the stainless-steel hydraulic grade piping and containing one or more identical alternators/generators connected to the same drive shaft.

If additional enclosed turbine units 103 are installed, these are installed in a parallel configuration with their own separate closed loop or channels to ensure maximum efficiency without pressure loss as you would find with series connected units. Each turbine unit 103 may have a separate start system.

As noted above, the second closed-loop pipeline 102b comprises a pneumatic motor 195 sequentially connected in-line with the stainless-steel hydraulic grade piping and may drive one or more connected auxiliaries to the drive shaft.

As noted above, the fluid propulsion means 110 has an electrically actuated cylinder pump system and/or a screw style air-accelerator interfaced to the stainless-steel hydraulic grade closed loop piping to maintain flow of the pressurised air in both the first close-loop pipeline 102a and/or the second closed-loop pipeline 102b through the turbine unit(s) 103 and/or pneumatic motor 195.

The system also comprises check valves 121a, 121b, 121c and 121d on the entry/exit ports of the fluid propulsion means 110. These are used to control the flow of fluid through the first closed-loop pipeline 102a and/or the second closed-loop pipeline 102b and/or to ensure fluid only flows in one direction through the first closed-loop pipeline 102a and/or the second closed-loop pipeline 102b.

The first closed-loop pipeline 102a comprise security and safety equipment such as a pressure relief valve 125 to discharge the air in case operational limits are exceeded and general monitoring of the whole system pressure and temperature. Although only the first closed-loop pipeline 102a is shown as having a pressure relief valve it will be understood that the second closed-loop pipeline 102b may also comprise a pressure relief valve.

The system also comprises other electronically monitored and activated safety systems such as temperature, pressure to include differential pressure across turbines and charging level.

As described above in the context of the example shown in FIG. 1, the system of FIG. 2 may also comprise cooling systems for the electrically actuated cylinder pump system and/or a screw style air-accelerator, loop(s), generators, and pneumatic motor.

In the example shown in FIG. 2, the turbine unit 103 is coupled to a battery comprising a BMS 197 which in turn is coupled to an inverter 199. This will provide a useful source of stored power.

When a dual loop system is used as shown in FIG. 2, the pneumatic motor 195 is connected to its own loop with an optional pressure reducing valve (not shown) to protect the motor. Intended use for the pneumatic motor vary from running a compressor, circulating coolant to being connected to a hydraulic pump.

It is known that compressed air has an increased power at high pressure, and this power will be harnessed due to the recirculation design of the first closed-loop pipeline 102a and the second closed-loop pipeline 102b. This high pressure compressed air rotates the turbine units 103 of the first closed-loop pipeline 102a to which the alternators are attached and the pneumatic motor 195 of the second closed-loop pipeline 102b.

As with the example of FIG. 1, starting the system of FIG. 2 requires the service of a high-pressure air vessel 111 which shall be charged with air in advance of system starting also in conjunction with any electrical battery charging. The high-pressure air vessel 111 commences an air delivery via a special designed manifold 118 to the turbine(s) 103 in sequence (if multiple turbines are fitted) and accordance with supervisory system commands. The compressed air supplied in the start sequence will be exhausted to atmosphere to ensure free flow through the turbine(s) to gain maximum speed. The duration of the start command depends upon supervisory system settings and continues until a positive system energy output occurs.

To continue circulation and regenerating energy from the returning air:
When the turbine rotor speed reaches a predefined value, the fluid propulsion means 110 is started.
As the circulation commences and based on a predefined value, the initial start system is disconnected, thus relying fully on the fluid propulsion means 110 to circulate the compressed air at a predefined value to sustain electricity generation.
The speed of the turbine(s) 103 will be controlled by the speed of the fluid propulsion means 110 thus controlling the flow of compressed air in the loops.
When the pressure in the pressure tank 111 falls below a predefined value, it is replenished by the compressor 112.
If the loop pressure is below a predefined value, a servo solenoid valve is opened and replenishes the pressure to a predefined value.
If the circulating loop pressure is above a predefined value, mechanical pressure relief valve(s) will be opened for safety and the excess pressure released into atmosphere or recuperated into the system.
The pressure tank 111 will be kept at a predefined value by the SMART compressors automation system.
Electricity is now generated by flowing compressed air through the closed loop system(s) and spinning the turbines 103.
The system is set up in a cycle. To produce electricity again in the continuation of the cycle, the pressure and speed lost after the turbine 103 must be regained. The continuing loop line establishes a connection from the turbine outlet to the fluid propulsion means 110. In this way, the low-energy air at the turbine exit is filled into the fluid propulsion means 110. The fluid propulsion means 110 will recirculate the low-energy air back into the system with high energy and as such, the continuity of the loop line is preserved. The fluid propulsion means 110 acts as the heart in a vascular system and as such ensures the continuation of the circulation of fluid from one section to another. Each time the returned fluid passes through the turbine 103, it will help to regenerate energy.

Compressed air has an increased power at high pressure, and this power will be harnessed due to the recirculation design of the closed loop. This high pressure compressed air rotates the turbine unit(s) 103 to which the alternators are attached.

The first component that initiates the circulation of the system is the pressure-filled tank 111. Before the operation starts, the pressure-filled tank 111 and battery 197 in the system are full. The start system 190 is initiated by the automation and supervisory system start command and continues until the alternator produces electricity. How long the start system will need to remain open is determined by the supervisory system automation and control function.

### Operating Control Sequences:

1. At start-up, the pressure tank 111 will provide a burst of up to 300bar of compressed air to the inlet side(s) of the turbine 103 via a proportional solenoid valve.
2. At that precise moment, an identical proportional solenoid valve will open on the outlet side of the turbine 103 and exhaust to atmosphere thus allowing the compressed air to flow freely across the turbine blades.
3. When the turbine rotor speed reaches a predefined value, the fluid propulsion means 110 unit is started.
4. As the circulation commences and based on a predefined value, both servo solenoid valves close thus relying fully on the fluid propulsion means 110 to circulate the compressed air at a predefined value to sustain electricity generation and pneumatic motor motion.
5. The speed of the turbine(s) will be controlled by the speed of the fluid propulsion means 110 by controlling the flow of compressed air in the loop. The pneumatic motor 195 will be set at 1350-1500 rpm.
6. When the pressure in the pressure tank 111 falls below a predefined value, it is replenished by the compressor 112.
7. If the loop pressure is below a predefined value, a servo solenoid valve is opened and replenishes the pressure to a predefined value.
8. If the circulating loop pressure is above a predefined value, two mechanical pressure relief valves opened for safety and the excess pressure released into atmosphere or recuperated into the system.
9. The pressure tank 111 may be kept at a predefined value by the SMART compressors automation system.
10. Electricity is now generated by flowing compressed air through the closed loop systems by spinning the turbines 103 and the pneumatic motor 195 is powered.
11. Electricity generated by the turbines 103 can be used for charging batteries and/or supplying energy to a grid, for example as shown in FIG. 1.
12. Apparatus connected to pneumatic motor 195 will pump or generate.
13. Dependent on the choice of generator (AC or DC), the generated electricity will either remain in its current form or be converted to either AC or DC depending on storage. AC converted to DC electric can be used to charge a battery which will supply the whole system. This option is also suitable for mobile applications.
14. If the generated electricity is for supplying a grid, the electricity will flow through a rectifier and then supplied to the network via the inverters. AC/AC convertors shown in FIG. 2.

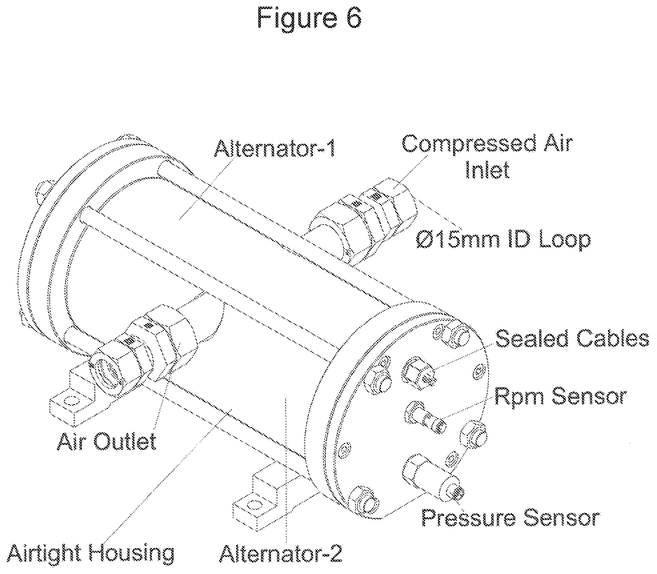

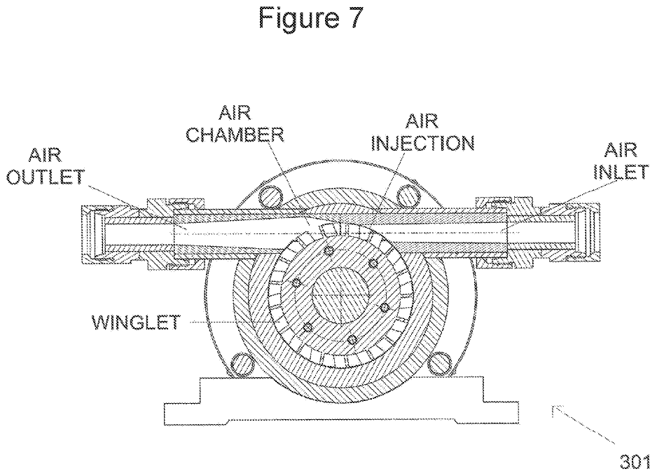

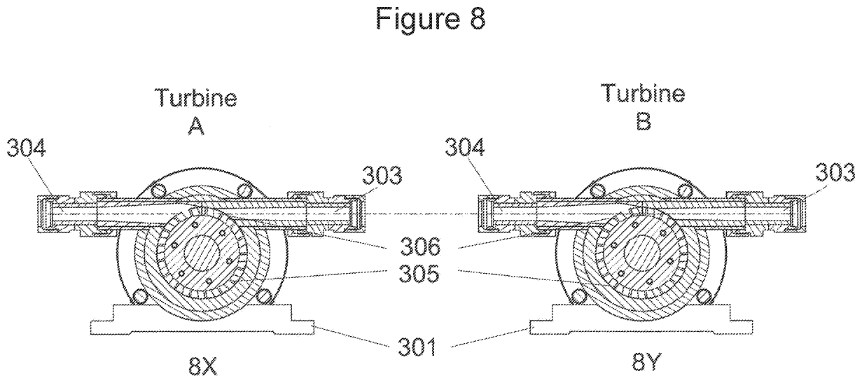

Referring now to FIGS. 6, 7, 8x, 8y, 12, show a cross-section of a turbine 301 that may, for example, be implemented with the example systems of FIG. 1 or FIG. 2. As can be seen from FIGS. 6, 7, 8x, 8y, 12, the turbine 301 comprises a turbine housing which comprises a turbine inlet 303 and a turbine outlet 304. Within the turbine housing, turbine fluid chambers 306 are separated by turbine winglets 305. As shown in FIGS. 7, 8x and 8y, the turbine blade profiles are optimized for a pulsating air flow therethrough and suitable for blade rotational speed from 3000 rpm to 20,000 rpm, directly proportional to air pressure and flow therethrough.

The turbine fluid intake 303 and outlet 304 may be of the same diameter and on the same axis.

As can be seen from FIGS. 8x and 8y, the turbine inlet 303 and the turbine outlet 304 are inline such that as fluid passes through the turbine it first impacts a turbine winglet 305 and the momentum of the fluid drives the winglet 305 from a first position shown in FIG. 8x to a second position shown in FIG. 8y. In the first position the turbine winglet 305 is located towards the turbine inlet 303 but the flow of the fluid drives the turbine winglet 305 towards the turbine outlet 304.

In the first position, the turbine fluid chamber 306 is filled with fluid entering the turbine 301 through the turbine inlet 303. In the second position, the fluid in the turbine fluid chamber 306 is released out of the turbine 301 through the turbine outlet 304.

This sequence is repeated continuously through the operation of the apparatus 101 and thereby rotates the turbine 301.

The turbine 301 further powered by a pressure difference between the fluid at the turbine inlet 303 and the fluid at the turbine outlet 304, namely a higher pressure at the turbine inlet 303 than at the turbine outlet 304.

FIG. 6 shows a perspective view of an illustration of the turbine 301 and shows a shaft protruding from the turbine housing 302 for mechanical attachment to a pair of alternators 308.

The turbine housing 302 comprised of metal. The alternators comprise permanent magnet rotors and suitable for power generation at 400 Hz.

The alternators may be capable of withstanding high rotational, varying speeds (acceleration) and, therefore, mechanical stress. It is anticipated that the alternators will be of permanent magnet rotor design and similar to those used on aircraft.

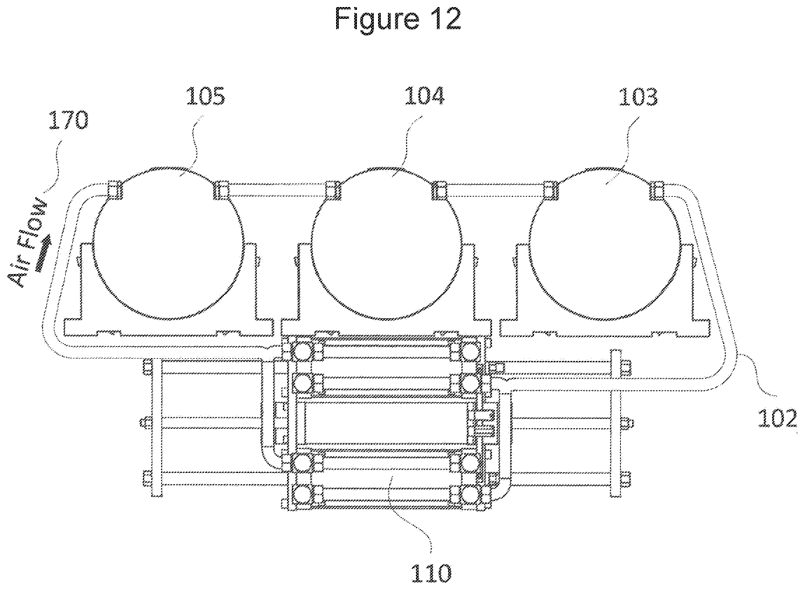

An enlarged view is shown in FIG. 12 and shows a plan view of the arrangement of the three turbines 103, 104, 105 as shown in FIG. 1.

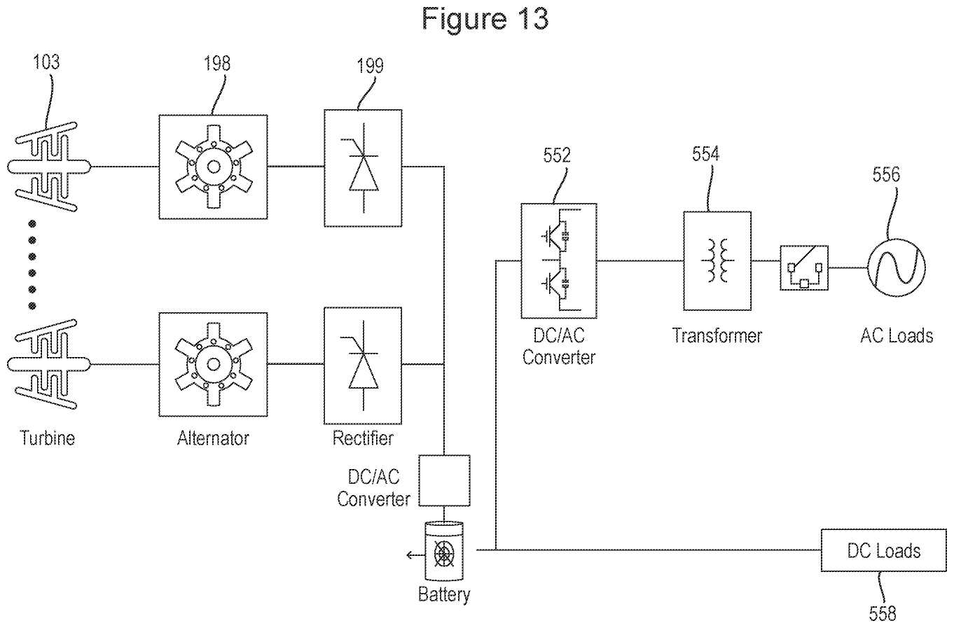

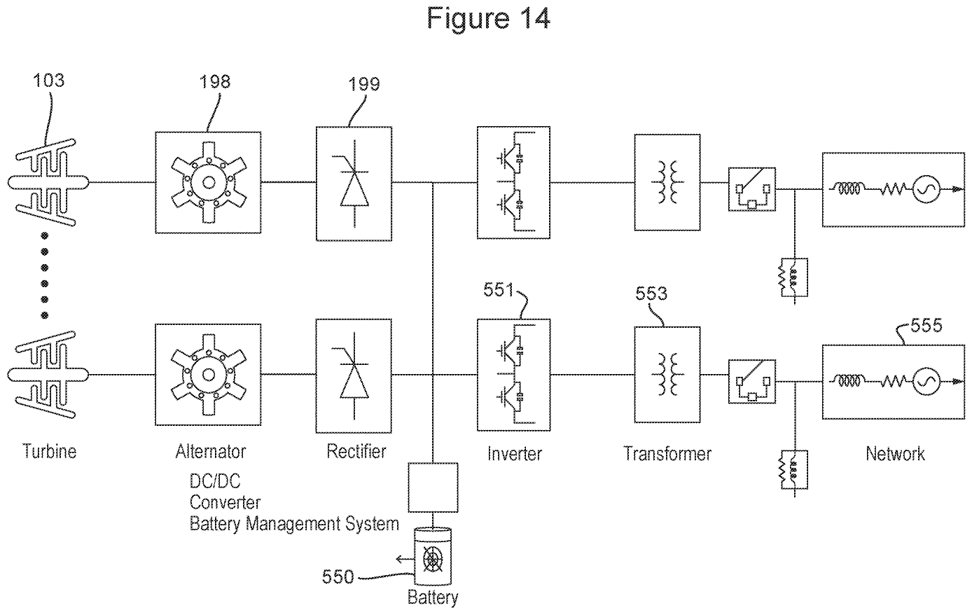

To convert the turbine mechanical output to useable electrical energy, an electrical interface for example as shown in FIGS. 13 and 14 comprising one or more of the following components may be used:
Electrical generator/alternator 198, (either permanent magnet, induction, or wound rotor synchronous. This may be for example a two pole, high speed permanent magnet design)
Frequency converter-rectifier unit 199, (with DC link to Inverter)
Frequency converter-inverter unit 551
Transformer 554, if necessary, for voltage matching and/or compatibility
Circuit Breaker and/or protective devices
Grid connection 555
Local Load (if present)
AC/DC converter 552 for battery voltage matching
Battery 550 and battery management system

In the example shown in FIG. 13, the turbine 103 is coupled to an alternator 198 which in turn is coupled to a rectifier 199. In the example shown there are two turbines 103, alternators 198 and rectifiers 199 in parallel. A battery 550 is coupled to the output of both rectifiers 199 optionally via a DC/DC converter. The battery 550 is either coupled to a DC load 558 or to an AC load 556 via a DC/AC converter 552, a transformer 554 and an optional circuit breaker and/or protective device.

In the example shown in FIG. 14, the turbine 103 is coupled to an alternator 198 which in turn is coupled to a rectifier 199. A battery 550 is coupled to the rectifier output in parallel with an inverter 551. A transformer 553 is coupled to the inverter 551. The transformer 553 is coupled to a grid/network 55 via an optional circuit breaker and/or protective device.

The electrical generator/alternator 198 may have a rating of 10 kW and/or a driver turbine 103 maximum operating speed of 20,000 rpm. A suitable generator 198 have two rotor magnetic poles therefore its maximum output frequency may be 166 Hz. It thus may be necessary to additionally incorporate a power electronic frequency converter, (PEC), to match the high generator frequency and varying voltage to a conventional distribution or local network. Electrical generators 198 incorporate internal voltage regulators. Since the electrical output of the generator 198 vary in response to changes in air pressure and velocity supplied to the turbine, the frequency converter 199 frequency and voltage may be optimally controllable such that output may be stable at 110-380V and/or 50 Hz, for example. A further interposing transformer 553 may be necessary to match any difference in voltage to either local or grid 555 connected supplies.

Individual power electronic converters may be incorporated such that control and synchronization of the generator outputs may be readily undertaken, and efficiency maintained.

As shown in FIGS. 2 and 13, a battery storage system (BESS) may be connected via a DC link of the Power Electronic Converter(s). This may consist of either Lead Acid or Lithium-Ion batteries. The BESS is intended to provide an electrical energy supply which can adequately compensate for variations in supply originating from the turbine generators/alternators 198.

The power electronic converter will take the form of a self-contained drive package whereby all rectifier 199 and inverter 551 components are included within a single cabinet. Alternatively, separate rectifier 199 and inverter 551 units may be provided. The use of separate units have an advantage in that convenient access to the DC link for battery connections can be provided.

Since the turbine/alternator configuration operating in a cyclic mode according to air pressure/flow variations, rotational speed and frequency may constantly vary between maximum and minimum values. The rectifier/inverter unit therefore be suitable for operating with such a regime, the Li-Ion battery being used to store electrical energy produced.

In the case where more than one turbine/alternator combination is utilized in a drive train, either in series or in parallel, it may be necessary to ensure that all final electrical outputs are correctly matched and synchronized together. This may be suitably accomplished using phase-locked-loop control circuitry built within the inverter section electronics. A further advantage of having separate and individually adjustable converter systems may be the ability to optimally adjust for discrepancies in load sharing and for speed differences between the generators. There may also be the provision of some redundancy should one generator combination fail.

FIG. 5 shows a perspective view of fluid propulsion means 110 which in this example is an electronically actuated cylinder pump system. The example electronically actuated cylinder pump system shown in FIG. 5 comprises four parallel cylinders 501a-d. The cylinders 501a-d are stacked two by two in a symmetrical arrangement, such that there is a pair of cylinders 501a, 501b on top, and a pair of cylinders 501c, 501d on the bottom, and such that the longitudinal axes of each of the cylinders 501a-d are parallel to each other. An end plate 505 couples the stack of cylinders 501a-d together at each end, and in the example shown bounds the ends of all the stack of cylinders 501a-d.

Inside each cylinder 501a-d is a respective piston 503a-d configured to reciprocate therewithin. Each piston 503a-d is mounted on a respective drive shaft 507a-d parallel to the longitudinal axis of each cylinder 501a-d and configured to move the corresponding piston 503a-d within its respective cylinder 503a-d along this longitudinal axis. Each pair of drive shafts 507a-d are coupled to a coupling bar 509 that extends in a direction transverse to the longitudinal axis of each cylinder 503a-d, such that the top two cylinders 501a, 501b are coupled by a first coupling bar 509 and the bottom two cylinders 501c, 501d are coupled by a second coupling bar 509.

Each coupling bar 509 is coupled to a corresponding actuating bar 513 extending from a corresponding actuator 511, which is mounted between each pair of cylinders 501a-d. Each actuator 511 may be electronically operated, and is configured to reciprocatably move its corresponding actuating bar 513 in a linear motion parallel to the longitudinal axis of each cylinder 501a-d such that the actuating bar 513 moves the coupling bar 509 and thereby each piston 503a-d via each respective drive shaft 507a-d.

In the example shown, the pistons 503a, 503b of the top two cylinders 501a, 501b are configured to reciprocate in a direction opposite to the direction of the pistons 503c, 503d of the bottom two cylinders 501c, 501d. Therefore, the first actuator 511 is configured to actuate its actuating bar 513 in a direction opposite to the second actuator 511, but still along an axis parallel to the longitudinal axis of each cylinder 501a-d. As such, the actuating bar 513 for the top two cylinders 501a. 501b extends in a direction opposite to that of the actuating bar 513 for the bottom two cylinders 501c, 501d.

Advantageously, operating the pistons 503a-d to counter-reciprocate in this manner provides a more balanced system for pumping fluid such as air around the closed loop system described above. Furthermore, by housing each actuator 511 between a corresponding pair of cylinders 501a-d, the propulsion means 110 is better balanced and can more efficiently pump a pair of cylinders 501a-d rather than requiring a respective actuator 511 for each cylinder 501a-d. Advantageously this balance out the motion of the pistons 503a-d to prevent and reduce movement, vibration, and noise from the cylinder pump system.

Each cylinder 501a-d may be arranged to have a respective fluid intake and output, or in each pair of cylinders 501 a, b and 501 c, d share a common fluid intake and output, such that the fluid propulsion means 110 may have a first fluid intake and a first fluid output, and a second fluid intake and a second fluid output. The first fluid intake and first fluid output are arranged to drive fluid in a first closed-loop pipeline, and the second fluid intake and the second fluid output is arranged to drive fluid in a second closed-loop pipeline, as shown in FIG. 2 as described above.

In the context of the present disclosure other examples and variations of the apparatus and methods described herein will be apparent to a person of skill in the art. It will be appreciated from the discussion above that the embodiments shown in the Figures are merely exemplary, and include features which is generalised, removed, or replaced as described herein and as set out in the claims.

1. An apparatus for generating electrical energy comprising:
fluid circulating apparatus, suitable for circulating pressurised fluid, comprising:
a first closed-loop pipeline and a second closed-loop pipeline, wherein the first closed-loop pipeline and the second closed-loop pipeline are coupled to a common fluid propulsion means, the fluid propulsion means comprising a first fluid intake and a first fluid output, and a second fluid intake and a second fluid output;
wherein the first closed-loop pipeline is coupled to the first fluid output and the first fluid intake of the fluid propulsion means and comprises at least one turbine comprising a turbine fluid intake and a turbine fluid output, wherein the turbine fluid output is connected to the first fluid intake of the fluid propulsion means by the first closed-loop pipeline, and wherein the first fluid output of the fluid propulsion means is connected to the turbine fluid intake by the first closed-loop pipeline; and
at least one alternator coupled to the at least one turbine such that rotation of the at least one turbine provides rotation to the alternator which in turn generates electrical energy.

2. An apparatus according to claim 1, wherein the fluid is air.

3. (canceled)

4. An apparatus according to claim 1, wherein the first closed-loop pipeline comprises a plurality of turbines.

5. An apparatus according to claim 1, wherein the fluid propulsion means comprises an electrically actuated cylinder pump system.

6. An apparatus according to claim 1, wherein the fluid circulating apparatus further comprises a cooling means, for cooling the pressurised fluid, comprising a cooling intake and a cooling output, wherein the cooling output is connected to the fluid intake of the fluid propulsion means by at least one of the first and the second closed-loop pipeline.

7. An apparatus according to claim 6, wherein the cooling means comprises any of: a fluid discharge valve, a cooling system, a surface cooler.

8. An apparatus according to claim 1, wherein the fluid propulsion means and the turbine are arranged in line with the first closed-loop pipeline.

9. An apparatus according to claim 1, further comprising a pressure tank, a compressor and a starting system for providing an initial fluid flow to overcome start up inertia of the turbine and/or motor-, and further comprising a reserve tank for supplying reserve fluid to the fluid circulating apparatus, wherein the reserve tank has a higher pressure than the fluid circulating apparatus.

10. (canceled)

11. An apparatus according to claim 1, wherein the apparatus for generating electrical energy further comprises an automation system, wherein the automation system comprises any of: control valves, check valves, sensors, temperature sensors, pressure sensors, flow sensors, control means, means for logging measurements.

12. (canceled)

13. An apparatus according to claim 1, wherein the apparatus for generating electrical energy further comprises at least one security component, wherein the at least one security component comprises any of: a motorised pressure relief valve, a mechanical pressure relief valve.

14. (canceled)

15. An apparatus according to claim 1, wherein the apparatus for generating electrical energy further comprises one, two or three additional pressurised tanks.

16. An apparatus according to claim 15, wherein the tanks are connected to one another and to the fluid circulating apparatus such that they maintain a continuous flow through the tanks and the fluid circulating apparatus.

17. An apparatus according to claim 9, wherein the reserve tank comprises at least one section of pipe which together substantially form an oval shape.

18. An apparatus according to claim 4, comprising a respective alternator coupled to each turbine, and wherein the alternator mechanically connected to the last turbine has a lower power rating than the alternator mechanically connected to the first turbine.

19. An apparatus according to claim 1, wherein the pressurised fluid is pressurised up to 100 bar.

20. An apparatus for generating electrical energy comprising:
fluid circulating apparatus, suitable for circulating pressurised fluid, comprising:
a closed-loop pipeline arranged to connect the components of the fluid circulating apparatus in series;
the components of the fluid circulating apparatus comprising:
a fluid propulsion means comprising a fluid intake and a fluid output, wherein the fluid propulsion means comprises two pairs of counter-reciprocating pistons mounted in respective cylinders, with each pair of pistons arranged to be driven by a common actuator;
at least on turbine comprising a turbine intake and a turbine output;
wherein the turbine output is connected to the fluid intake by the closed-loop pipeline;
wherein the fluid output of the fluid propulsion means is connected to the turbine intake by the closed-loop pipeline;

21. The apparatus according to claim 20 further comprising:
a reserve tank arranged to supply reserve fluid to the fluid circulating apparatus;
a pressure tank for providing an initial fluid flow to overcome a start-up inertia of the at least one turbine, the pressure tank comprising a compressor to maintain a predetermined pressure in the pressure tank;
at least one alternator coupled to the at least one turbine such that rotation of the turbine provides rotation to the alternator which in turn generates electrical energy.

22. The apparatus according to claim 20 wherein the fluid propulsion means comprises two actuators, each actuator configured to drive a corresponding pair of pistons.

23. The apparatus according to claim 22 wherein a first actuator is configured to move a first pair of pistons in a first direction while the second actuator is configured to simultaneously move the second pair of pistons in an opposite second direction.

24. The apparatus according to claim 22 wherein each actuator is mounted between its corresponding pair of pistons.
